(19) United States
(12) Patent Application Publication
(10) Pub. No.: US 2012/0219784 A1
(43) Pub. Date: Aug. 30, 2012

(54) USE OF A REGENERATED CELLULOSE FIBER IN A FLAME-RETARDANT PRODUCT

(75) Inventor: Ingo Bernt, Regensburg (DE)

(73) Assignee: Kelheim Fibres GmbH, Kelheim (DE)

(21) Appl. No.: 13/387,270

(22) PCT Filed: Jul. 9, 2010
(86) PCT No.: PCT/EP10/59867

§ 371 Date: May 8, 2012

(30) Foreign Application Priority Data
Jul. 31, 2009 (EP) 09450141.8

(51) Int. Cl. D01F 2/06; A47C 27/00; D01F 1/07; C09K 21/06; C08B 16/00

(52) U.S. Cl. 428/221; 252/601; 536/57; 428/401; 2/458; 5/698

(57) ABSTRACT

The invention relates to the use of a regenerated cellulose fiber, in which carboxymethylcellulose is incorporated, in a flame-retardant product.

### BACKGROUND OF THE INVENTION

The present invention relates to the use of a regenerated cellulose fiber, which is obtained by the viscose process, in flame-retardant products.

Flame-retardant viscose fibers have many fields of application, such as, e.g., safety clothing, mattress fillings, textiles for interior use, etc., intending to provide general safety and protection.

There have been known already different types of flame-retardant viscose fibers:

On the one side, it is known to provide viscose fibers with flame-retardancy by integration of polysilicic acid. The integration of polysilicic acid, however, leads to the formation of rigid, brittle fibers, which are suitable for fleece textiles rather than for textile uses.

Under the trade name Lenzing FR® there are marketed viscose fibers, which are obtained by the integration of a phosphorus-containing additive. In order to obtain a sufficient flame-retardancy with phosphorus-containing additives, there has to be accomplished a high level of integration. This will lead, due to the high costs of additives, to a rather high final price of the fiber.

There is existent a variety of proposals for subsequently conferring flame-retardancy to cellulose fibers, this is, application onto the already fabricated fibers, such as, e.g., Probane (THPC) and Pyrovatex® CP.

Textiles/fibers that are post-treated in such a way, however, only have a limited resistance to washing. Due to the cross-linking chemistry used, there are developed residual amounts of formaldehyde, which presents a health risk. Furthermore, the cross-linking reaction causes an embrittlement and stiffening of the fibers/textiles.

The U.S. Pat. No. 3,734,683 describes the flame-retardant effect of the cellulosic fibers with a higher portion of carboxy groups due to the production of a carboxycellulose. According to this publication, viscose fibers are oxidized in a complex method and subsequently post-treated. In an economically sound process for the production of fibers, this method cannot be carried out. The mentioned oxidation would, furthermore, lead to damage to the fiber structure and a flawed processability.

### SUMMARY OF THE INVENTION

The object of the present invention is to provide a cost-efficient and effective flame-retardant fiber, which is easy to process in the conventional textile processes.

This aim is solved by the use of a regenerated cellulose fiber, in which carboxymethylcellulose is incorporated, in a flame-retardant product.

### DETAILED DESCRIPTION OF THE INVENTION

It has surprisingly been shown that a regenerated cellulose fiber, which has incorporated carboxymethylcellulose (CMC), acts as a flame-retardant and may be processed in a comparably cheap as well as good way.

Under the measure that there is incorporated carboxymethylcellulose into the fiber the expert understands that the CMC is integrated in the matrix of the (upon regeneration of the fiber) underivatized cellulose. This is—in contrast to the application of CMC onto the already fabricated fiber—possible, among other, by spinning in CMC into the viscose dope.

Viscose fibers with a portion of carboxymethylcellulose (CMC) have been known. This is a mixed fiber, which is obtained by spinning in carboxymethylcellulose into the viscose dope. Such fibers were also produced on a commercial level (U.S. Pat. No. 4,199,367 A, U.S. Pat. No. 4,289,824 A).

There is produced, for example, a viscose dope according to the conventional methods. There are added to the dope, directly before the spinning out, 8-12% by weight solution of carboxymethylcellulose (CMC) so that this leads to the desired integration amount based on underivatized cellulose. Post-treatment and drying are carried out according to the conventional methods.

The portion of incorporated carboxymethylcellulose in the regenerated cellulose fiber is preferably 5% by weight to 50% by weight, especially preferably 15% by weight to 40% by weight, most preferably 20% by weight to 30% by weight, based on underivatized cellulose.

The carboxymethylcellulose may be a commercially available product with a degree of substitution of 0.6-12, preferably 0.65-0.85 and a viscosity (2% solution; 25° C.) of 30-800 mPas; preferably 50-100 mPas.

The CMC containing regenerated cellulose fiber used according to the invention is also designated as ,,viscose-CMC mixed fiber” in the following.

The fiber titer of the viscose-CMC mixed fiber is preferably from 0.5 dtex to 8 dtex, especially preferably from 1.3 to 6 dtex.

The fiber length of the viscose-CMC mixed fiber used according to the invention may be 2 mm to 80 mm and is in particular dependent on the field of application. For a wet-laid process, there are suitable fiber lengths of 2 to 20 mm, for a carding process, there are suitable fiber lengths of 20 to 80 mm.

The viscose-CMC mixed fiber contains preferably another flame-retardant additive. This further additive may be in particular selected from the group consisting of halogen containing additives, phosphorus containing additives, aluminum and magnesium salts and polysilicic acids. The further additive may be incorporated in the fiber in the known method of spinning into the viscose dope (e.g., in the case of phosphorus-containing additives such as, e.g., Exolit® 5060) or being subsequently applied onto the fiber (e.g., in the case of alkaline solutions of an aluminum salt).

The viscose-CMC mixed fiber used according to the invention or textiles or fleece cloths that contain these, respectively, discontinue to burn in contrast to viscose fibers or products made from pure viscose fibers following ignition. The flame extinguishes immediately, and the fiber merely continues to smolder. Especially pronounced is this effect in association with an integration of 20% by weight CMC based on underivatized cellulose.

The viscose-CMC mixed fibers used according to the invention, however, differ—in contrast to some of the already known flame-retardant viscose fibers—in their values of tenacity and elongation values as well as their elasticity not substantially from conventional viscose fibers and thus may be processed in the same way as these.

The additive (CMC) used for the fibers according to the invention does not present a health risk and is even used as foodstuff additive. Embrittlement and stiffening of the fibers does not occur. The flame-retardant effect is resistant to washing in a nearly unlimited way.

Accordingly, the present invention also relates to a flame-retardant product, containing a regenerated cellulose fiber, in which carboxymethylcellulose is incorporated.

The flame-retardant product according to the invention is preferably characterized in that the portion of incorporated carboxymethylcellulose in the cellulose fiber is 5% by weight to 50% by weight, preferably 15% by weight to 40% by weight, especially preferably 20% by weight to 30% by weight based on underivatized cellulose.

The flame-retardant product according to the invention may contain preferably the viscose-CMC mixed fiber in a portion of 10% -100%.

The flame-retardant product according to the invention is preferably selected from the group consisting of clothing, in particular safety clothing, home textiles, in particular mattresses, automobile textiles, filter materials and insulation materials for the construction and automobile field.

### EXAMPLES

There were produced in a well-known viscose process—CMC mixed fibers with a portion of 0% (zero samples), 12% by weight, 20% by weight and 30% by weight CMC based on underivatized cellulose. The fibers were cut to a staple length of 40 mm.

From the fiber samples there were produced rotor rings each having 10 g. The rotor rings were subsequently opened and pressed by a tampon calandar. The produced bands have a weight per unit area of about 238 g/m² (206-260 g/m²) with a thickness of about 5 mm.

For the fire tests there were cut test samples with a size of 8×2 cm. The test samples were horizontally or vertically clamped, and the free end of the sample was fired over a defined period of time with a Bunsen burner.

### Results:

Conventional viscose fiber (0% CMC):

The samples ignited already at is firing time and subsequently continued to burn with a dynamic pattern until complete combustion.

Viscose fibers with 12% or 20%, respectively, CMC (according to the invention):

The test sample incinerates upon direct contact with the burner flame. If the flame is removed, the sample, however, will immediately extinguish (“self-extinguishing”). In some cases several individual fibers that projected beyond the test sample continued to burn upon removal of the flame.

The flaming time was varied from 1 s—10 s. All samples extinguished directly upon removal of the flame. There was increased only the burnt portion due to longer contact with the burner flame.

All samples still smoldered upon extinction. In all cases, there was developed a slow and complete ashing of the test samples.

1. A flame-retardant product comprising a regenerated cellulose fiber which comprises carboxymethylcellulose.

2. The flame-retardant product according to claim 1, wherein the cellulose fiber comprises 5% by weight to 50% by weight carboxymethylcellulose based on underivatised cellulose.

3. The flame-retardant product according to claim 1 or 2, wherein the cellulose fiber has a titer between 0.5 dtex and 8 dtex.

4. The flame-retardant product according to claim 1 or 2, wherein the cellulose fiber has a length from 2 mm to 80 mm.

5. The flame-retardant product according to claim 1 or 2, wherein the cellulose fiber comprises a further flame-retardant additive.

6. The flame-retardant product according to claim 5, wherein the further flame-retardant additive is selected from the group consisting of halogen-containing additives, phosphorus-containing additives, aluminium and magnesium salts and polysilicic acids.

7. (canceled)

8. (canceled)

9. The flame-retardant product according to claim 1 or 2, wherein said product comprises the regenerated cellulose fiber in a portion of 10%-100%.

10. The flame-retardant product according to claim 1 or 2, wherein said product is selected from the group consisting of clothing, home textiles, automobile textiles, filter materials and insulation materials for the construction and automobile field.

11. The flame-retardant product according to claim 2, wherein the cellulose fiber comprises 15% by weight to 40% by weight carboxymethylcellulose based on underivatised cellulose.

12. The flame-retardant product according to claim 2, wherein the cellulose fiber comprises 20% by weight to 30% by weight carboxymethylcellulose based on underivatised cellulose.

13. The flame-retardant product according to claim 3, wherein the cellulose fiber has a titer between 1.3 dtex and 6 dtex.

14. The flame-retardant product according to claim 10, wherein said clothing is safety clothing.

15. The flame-retardant product according to claim 10, wherein said home textile is a mattress textile.

16. A method of making a flame-retardant product comprising providing a regenerated cellulose fiber which comprises carboxymethylcellulose.

17. The method according to claim 16, wherein the cellulose fiber comprises 5% by weight to 50% by weight carboxymethylcellulose based on underivatised cellulose.

18. The method according to claims 16 and 17, wherein the cellulose fiber has a titer between 0.5 dtex and 8 dtex.

19. The method according to claims 16 and 17, wherein the cellulose fiber has a length from 2 mm to 80 mm.

20. The method according to claims 16 and 17, wherein the cellulose fiber comprises a further flame-retardant additive.

21. The method according to claims 16 and 17, wherein the further flame-retardant additive is selected from the group consisting of halogen-containing additives, phosphorus-containing additives, aluminium and magnesium salts and polysilicic acids.

22. The method according to claim 17, wherein the cellulose fiber comprises 15% by weight to 40% by weight carboxymethylcellulose based on underivatised cellulose.

23. The flame-retardant product according to claim 17, wherein the cellulose fiber comprises 20% by weight to 30% by weight carboxymethylcellulose based on underivatised cellulose.

24. The flame-retardant product according to claim 18, wherein the cellulose fiber has a titer between 1.3 dtex and 6 dtex.
